(19) United States
(12) Patent Application Publication
(10) Pub. No.: US 2008/0159407 A1
(43) Pub. Date: Jul. 3, 2008

(54) Mechanism for a parallel processing in-loop deblock filter

(76) Inventors: Nick Y. Yang, Granite Bay, CA (US); Hong Jiang, El Dorado, CA (US)

Correspondence Address: INTEL/BLAKELY, 1279 OAKMEAD PARKWAY, SUNNYVALE, CA, 94085-4040, US

(21) Appl. No.: 11/648,030

(22) Filed: Dec. 28, 2006

(51) Int. Cl. H04N 7/24

(52) U.S. Cl. 375/240.25; 375/E07.02

(57) ABSTRACT

In one embodiment, an apparatus and method for a parallel processing in-loop deblock filter are disclosed. In one embodiment, the method comprises: receiving a video input including a frame to be in-loop deblocked by an in-loop deblock (ILDB) filter; determining whether a macroblock (MB) of one row of the frame satisfies prerequisite conditions for the MB to be in-loop deblocked, the prerequisite conditions including an immediate left neighbor and an immediate upper-right neighbor of the MB both having completed in-loop deblocking by the ILDB filter; in-loop deblocking, by the ILDB filter, the MB if the MB satisfies the prerequisite conditions; and concurrently starting the ILDB filter on another MB in another row of the frame, the another MB having also satisfied the conditions. Other embodiments are also described.

### FIELD OF THE INVENTION

The embodiments of the invention relate generally to the field of video signal processing and, more specifically, relate to a mechanism for a parallel processing in-loop deblock filter.

### BACKGROUND

In block-based video coding schemes, blocking artifacts are an inherent and inevitable occurrence, especially at low bit rates. Blocking artifacts occur because block edges in a video coding scheme are typically predicted with less accuracy than interior samples in the block. Block transforms also produce block edge discontinuities. To counter blocking artifacts, video coding schemes implement a deblocking filter. The deblocking filter reduces blockiness while basically retaining the sharpness of the true edges in the scene.

In more recent video coding schemes, such as the H.264/Advanced Video Coding (AVC) specification (ITU-T H.264 standard, approved March, 2005), the deblocking filter is introduced into the motion compensation loop in the video coding. This type of deblocking filter is known as an in-loop deblocking (ILDB) filter. The ILDB filter can thereby bring its ability to improve picture quality for utilization in inter-picture prediction to improve the ability to predict other pictures.

However, one drawback of the ILDB filter's algorithm is that it requires all macroblocks (MBs) to be filtered one by one in scan line order, as depicted in Table 1 for non-MBAFF mode pictures and Table 2 for MBAFF mode pictures. This serial processing approach greatly limits ILDB filter throughput on a multi-core processor.

TABLE 1
(Original MB sequence order in a progressive frame picture or an
interlaced field picture (MBAFF = 0) with dimension of 5 MBs × 6 MBs)

| | 0 | 1 | 2 | 3 | 4 |
|---|---|---|---|---|---|
| 0 | 0 | 1 | 2 | 3 | 4 |
| 1 | 5 | 6 | 7 | 8 | 9 |
| 2 | 10 | 11 | 12 | 13 | 14 |
| 3 | 15 | 16 | 17 | 18 | 19 |
| 4 | 20 | 21 | 22 | 23 | 24 |
| 5 | 25 | 26 | 27 | 28 | 29 |

TABLE 2
(Original MB sequence order in an interlaced frame picture
(MBAFF = 1) with dimension of 5 MBs × 6 MBs)

| | 0 | 1 | 2 | 3 | 4 |
|---|---|---|---|---|---|
| 0 | 0 | 2 | 4 | 6 | 8 |
| 1 | 1 | 3 | 5 | 7 | 9 |
| 2 | 10 | 12 | 14 | 16 | 18 |
| 3 | 11 | 13 | 15 | 17 | 19 |
| 4 | 20 | 22 | 24 | 26 | 28 |
| 5 | 21 | 23 | 25 | 27 | 29 |

As shown in the Table 1, the MBs are processed serially beginning with MB 0 and increasing sequentially through MB 29. In Table 2, although the MBs are processed in pairs, they are still processed sequentially. For example, MB pair 0, 1 is processed first, followed by MB pair 2, 3, and so on finishing with MB pair 28, 29. The prior art ILDB filter algorithm further requires filtering a single MB's vertical external and internal edges from left to right, and then filtering its horizontal external and internal edges from top to bottom. The vertical filtered results are used as input to the horizontal filtering process. Thus, the order dependency determines the final results.

The serial processing of the prior art techniques is not advantageous for a multi-core processor capable of parallel processing. A mechanism to allow for parallel processing of the ILDB algorithm would be beneficial.

### BRIEF DESCRIPTION OF THE DRAWINGS

The invention will be understood more fully from the detailed description given below and from the accompanying drawings of various embodiments of the invention. The drawings, however, should not be taken to limit the invention to the specific embodiments, but are for explanation and understanding only.

FIG. 1 illustrates a block diagram of one embodiment of a high-level architecture for a digital video codec;

FIG. 2 is pseudo code for one embodiment of the invention;

FIG. 3 is pseudo code for another embodiment of the invention;

FIG. 4 is a graphical illustration of one embodiment of the invention; and

FIG. 5 illustrates a block diagram of one embodiment of a computer system.

### DETAILED DESCRIPTION

A method and apparatus for a parallel processing in-loop deblock filter are described. In the following detailed description of the present invention, numerous specific details are set forth in order to provide a thorough understanding of the present invention. However, it will be apparent to one skilled in the art that the present invention may be practiced without these specific details. In other instances, well-known structures and devices are shown in block diagram form, rather than in detail, in order to avoid obscuring the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Embodiments of the invention present a mechanism for a parallel processing in-loop deblock (ILDB) filter. More specifically, embodiments of the invention describe a parallel algorithm for an ILDB filter for use with a multi-core processor. The parallel algorithm fully explores inter macro block (MB) dependencies of the ILDB filter, while allowing for multiple MBs filtered in parallel in order to achieve higher throughput on a multi-core processor.

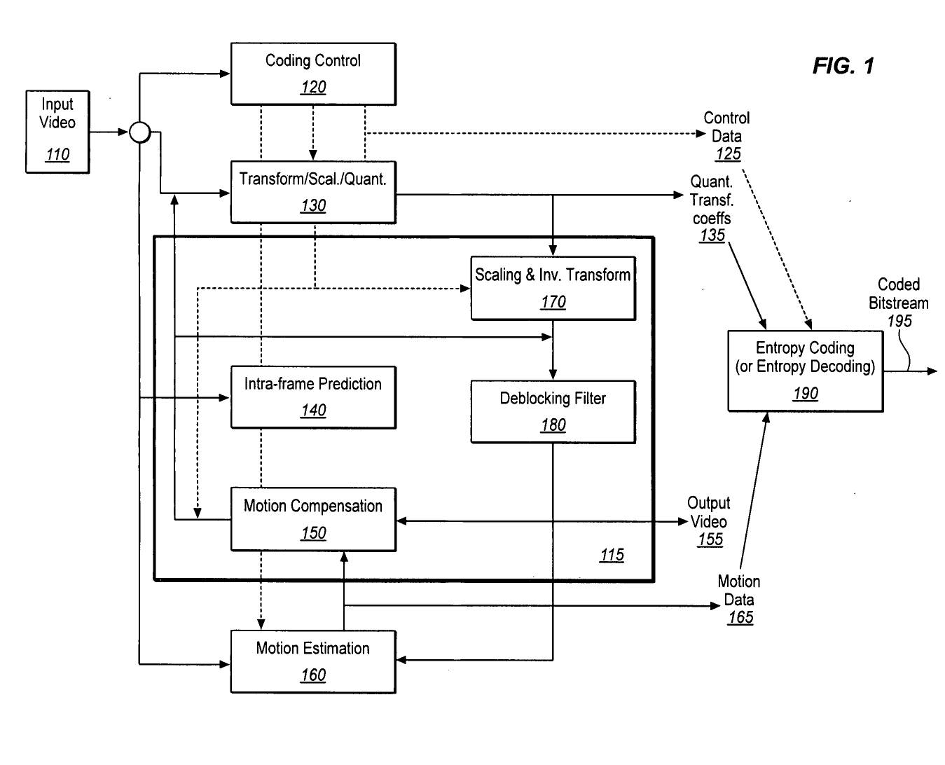

FIG. 1 is a block diagram depicting one embodiment of an exemplary high level architecture for a digital video codec, such as the H.264/AVC video coding standard. System 100 receives an input video stream 105 to be compressed for transport and/or storage. Each picture of the input video 105 is split into MBs. The first picture (or any other “clean” random access point) of the input video 105 is typically coded in Intra mode 140 (typically using some prediction from region-to-region within the picture but has no dependence on other pictures).

For all remaining pictures of the input video 110 or between random access points, typically Inter-picture coding modes 120 are used for most blocks. The encoding process for Inter prediction (ME) consists of choosing motion data 150, 160 comprising the selected reference picture and motion vectors (MV) to be applied for all samples of each block. The motion and mode decision data, which are transmitted as side information 125, 165, are used by an encoder and a decoder to generate identical Inter prediction signals using motion compensation (MC) 150.

The residual of the Intra and Inter prediction, which is the difference between the original block and its prediction, is transformed by a frequency transform 130. The transform coefficients are then scaled 170, quantitized 130, entropy coded 190, and transmitted together with the prediction side information in the coded bitstream 195.

System 100 further duplicates the decoder processing so that both will generate identical predictions for subsequent data. Therefore, the quantitized transform coefficients 135 are constructed by inverse scaling and are then inversed transformed 170 to duplicate the decoded prediction residual. The residual is then added to the prediction, and the result of that addition may then be fed into a deblocking filter 180 (ILDB filter) to smooth out block-edge discontinuities induced by the block-wise processing. The final picture 155 (which is also displayed by the decoder) is then stored for the prediction of subsequent encoded pictures.

While an encoder diagram is shown in FIG. 1, a decoder for the digital video codec conceptually works in reverse, including primarily an entropy decoder (in place of entropy coder 190) and the processing elements of the region 115.

Embodiments of the invention provide an efficient parallel processing algorithm for an ILDB filter, such as deblocking filter 180 from FIG. 1. This parallel algorithm achieves identical filtering results as prior serial processing ILDB filters, but with a different MB execution order. Embodiments of the invention eliminate the requirement of filtering MBs one-by-one by allowing the filtering of one MB per row of the picture concurrently, as long as certain dependencies are satisfied. Specifically, under the parallel ILDB algorithm of embodiments of the invention, all dependency orders are met at the pixel level so that the final results of the ILDB filter are identical to the prior art algorithm's results.

Table 3 below depicts a novel non-MBAFF (MB-adaptive frame/field mode) MB walking pattern of embodiments of the invention. Additionally, Table 4 below depicts a novel MBAFF MB walking pattern. These walking patterns allow for parallel processing in the ILDB filter by running multiple threads on multi-core processors, while still maintaining dependency orders. The walking patterns depicting in Tables 3 and 4 start ILDB filtering at MB 0 and continue in increasing sequential numerical order (e.g., 0, 1, 2, . . . , 29). Notice that in the MBAFF case of Table 4, every two MBs are grouped as a MB pair, e.g. MB 0 and 1, MB 2 and 3, etc., and the MB pair walking pattern is identical to the MB walking pattern in the non-MBAFF case of Table 3.

It should be noted that Tables 3 and 4 depict a picture with dimensions of 5 MBs by 6 MBs. One skilled in the art should appreciate that a picture on which the ILDB filter algorithm of embodiments of this invention may apply may have a variable number of MBs, and embodiments of the invention are not necessarily limited to the particular depiction presented in the present description.

TABLE 3
(New MB sequence order in a progressive frame picture or an
interlaced field picture (MBAFF = 0) with dimension of 5 MBs × 6 MBs)

| | 0 | 1 | 2 | 3 | 4 |
|---|---|---|---|---|---|
| 0 | 0 | 1 | 2 | 4 | 6 |
| 1 | 3 | 5 | 7 | 9 | 11 |
| 2 | 8 | 10 | 12 | 14 | 16 |
| 3 | 13 | 15 | 17 | 19 | 21 |
| 4 | 18 | 20 | 22 | 24 | 26 |
| 5 | 23 | 25 | 27 | 28 | 29 |

TABLE 4
(New MB sequence order in an interlaced frame picture (MBAFF = 1)
with dimension of 5 MBs × 6 MBs)

| | 0 | 1 | 2 | 3 | 4 |
|---|---|---|---|---|---|
| 0 | 0 | 2 | 4 | 8 | 12 |
| 1 | 1 | 3 | 5 | 9 | 13 |
| 2 | 6 | 10 | 14 | 18 | 22 |
| 3 | 7 | 11 | 15 | 19 | 23 |
| 4 | 16 | 20 | 24 | 26 | 28 |
| 5 | 17 | 21 | 25 | 27 | 29 |

Embodiments of the invention provide for logic to select the next MB in the walking pattern, as follows:

```
If (Next MB is inside of the present picture) {
    Next MB row = Current MB row + 1;
    Next MB column = Current MB row − 2;
} else {
    Next MB row = Top-most row of the picture that has unfiltered MB;
    Next MB column = Left-most column of Next MB row unfiltered;
}
```

Embodiments of the invention provide for prerequisite dependency conditions to be established before an MB may begin ILDB filtering. The prerequisite dependency condition includes that each MB may be filtered only after its upper right neighbor and left neighbor have completed filtering. This requirement ensures all inter-MB dependencies are met. If a MB does not have an upper right neighbor or a left neighbor, it is assumed that this condition is satisfied. Note that the above walking pattern depicted in Tables 3 and 4 implies the upper right neighbor requirement is guaranteed to be met.

As a result of the above prerequisite conditions, embodiments of the walking pattern of the parallel algorithm of embodiments of the invention allow multiple MBs on different rows in a same picture to be processed concurrently. This concurrent processing may be carried out on a multi-core processor by separate child threads running concurrently. Inter-thread communication enables the root threads to control the throttling of child thread-spawning rates based on a child thread's execution status.

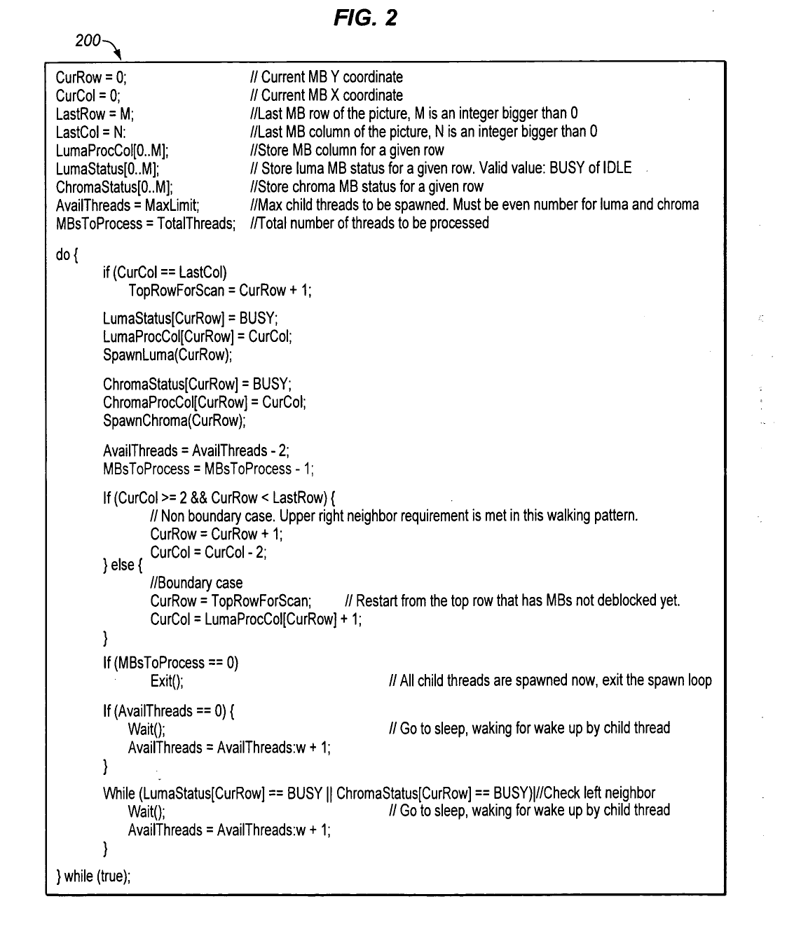

FIG. 2 provides pseudo code 200 depicting the parallel ILDB filtering algorithm of embodiments of the invention. Specifically, pseudo code 200 depicts the parallel ILDB filtering algorithm for root threads in the non-MBAFF case. Each MB's luma and chroma components are filtered concurrently on separate root threads for increased thread parallelism. It should be noted that pseudo code 200 also works for the MBAFF case by replacing a single MB with a MB pair, and having each thread filter a MB pair.

As each row may only have one MB filtered at a time from left to right, a small number of 1-dimensional (1-D) scoreboards may be utilized to fully track the status of multiple 2-dimensional (2-D) MBs. Note that an MB search is not required as the child spawning order is predetermined in the walking pattern of the parallel algorithm, which simplifies the logic of finding the next MB to spawn.

In conjunction with pseudo code 200, a first 1-D scoreboard may be utilized to keep track of the location of the MBs that are being filtered. In the first scoreboard, MB(x, y) is the active MB being filtered, where column ‘x’ is stored in the scoreboard at offset ‘y’ (which also represents MB's row). A second 1-D scoreboard keeps track of whether a luma component of MB(x,y) is filtering or has completed its filtering. Similarly, a third 1-D scoreboard keeps track of whether a chroma component of MB(x,y) is filtering or has completed its filtering. The first scoreboard is updated by the root thread. The second and third scoreboards are updated by both of the root thread and its child threads via one-way communication from child thread to root thread.

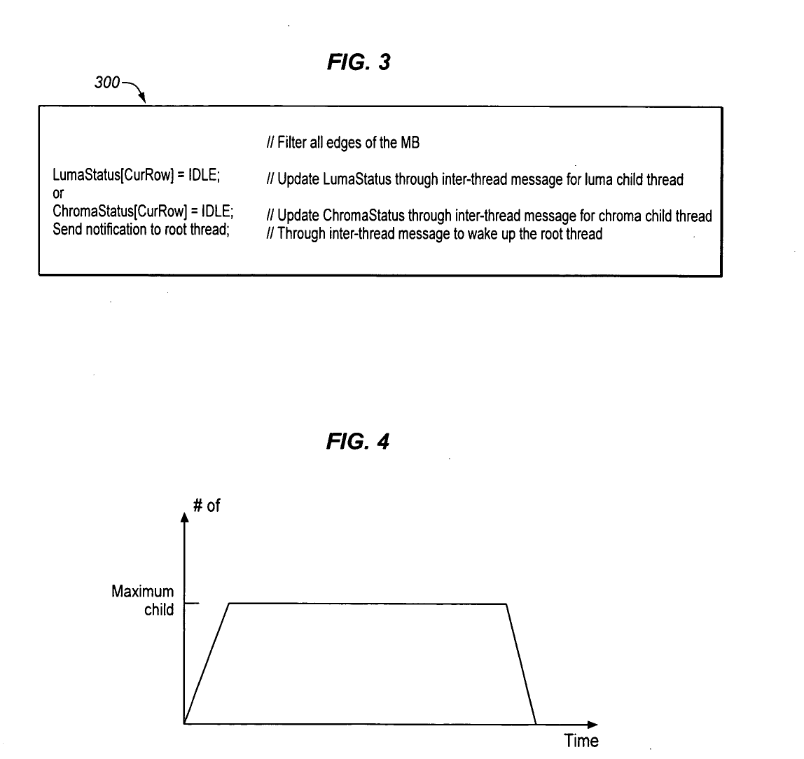

FIG. 3 depicts pseudo code 300 representing operations of a child thread of embodiments of the invention. As shown in pseudo code 300, when a child thread completes ILDB filtering, it must update the scoreboard accordingly and send a notification to the root thread to wake it up. As mentioned above, this one-way communication from the child thread to the root thread allows the second and third scoreboards to be updated.

Yet another novel embodiment of the invention involves dual root threads running in parallel and spawning luma and chroma child threads independently. This embodiment increases the child thread spawning throughput and removes lock-step luma-chroma dependency imposed in the single root thread algorithm. The two root threads share the available thread pool for spawning their child threads respectively. As the chroma component is completes ahead of the luma component, the luma root thread may utilize all available threads in the thread pool to maximize the parallel operations.

Embodiments of the invention apply novel techniques for ILDB filtering as depicted by the pseudo code of FIGS. 2 and 3. These novel techniques include the use of scoreboard for dependency control, particularly mapping a 2-D dependency graphic into a handful of 1-D scoreboards. This significantly reduces the storage requirement. Another novel technique is the splitting of the luma and chroma processing of a MB into two separate threads and using hierarchical scoreboards to manage out-of-order thread termination and MB dependency.

FIG. 4 is a graphical depiction showing the approximate profile of thread concurrency in a video frame. The maximum of number of child threads, M, that may be running concurrently is the minimum of A and B, represented as M=min(A, B). In the previous equation, A=(# of MBs in picture height)×(video component), where video component=2 for NV12, 3 for IMC4, etc. In addition, B=maximum threads the underlying multi-core processor is capable of supporting. As shown in FIG. 4, the starting ramp up and ending ramp down are caused by the inter-MB dependencies. The middle flat portion is determined by the maximum active child threads.

Previously, the prior art H.264/AVC ILDB algorithm was suitable to run on platforms supporting single threads only. Typically, the ILDB was performed with software using a CPU or multi-stage pipeline hardware. The software solution was subject to the CPU performance, which tends to be lower performance and higher power. The multi-stage pipeline implementation had far less parallelism compared to array processor engines due to the inter-MB dependencies.

In comparison, the parallel algorithm of embodiments of the invention fully explores inter-MB dependencies of the AVC ILDB filter and allows multiple MBs filtered in parallel to achieve higher throughput on a multi-core processor. Embodiments of the invention are more flexible and scalable to multi-core processors with a different number of cores.

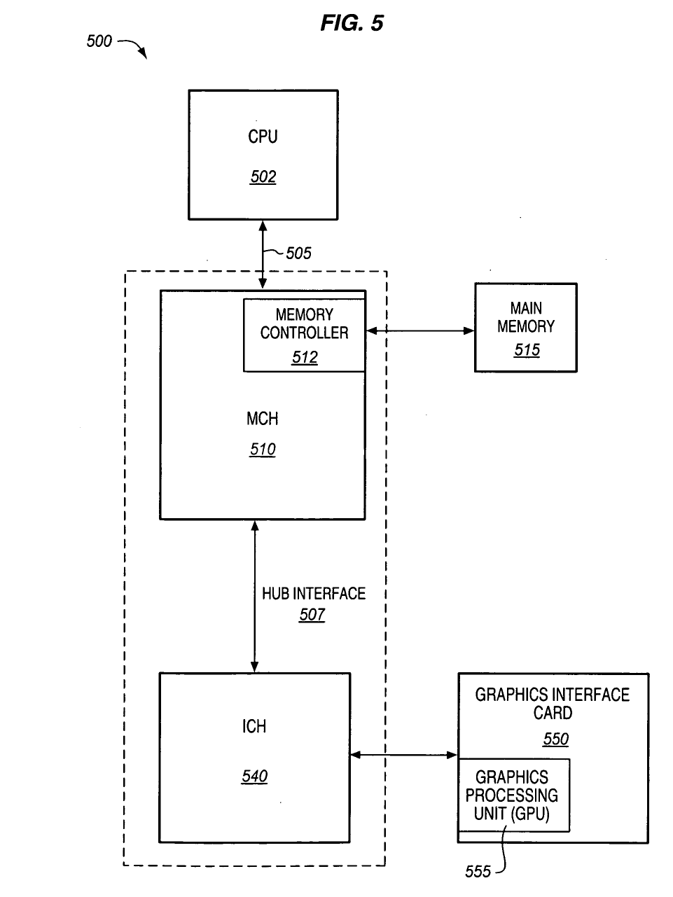

FIG. 5 is a block diagram of one embodiment of a computer system 500. In some embodiments, computer system 500 includes the components of FIG. 1 and performs their associated functions. For instance, in some embodiments, graphics interface card 550 may include the components of FIG. 1 and perform the functions described by the pseudo code of FIGS. 2 through 3. For example, encoder system 100, including deblocking filter 180, may be part of graphics interface card 550.

Computer system 500 includes a central processing unit (CPU) 502 coupled to interconnect 505. In one embodiment, CPU 502 is a processor in the Pentium® family of processors Pentium® IV processors available from Intel Corporation of Santa Clara, Calif. Alternatively, other CPUs may be used. For instance, CPU 502 may be implemented multiple processors, or multiple processor cores.

In a further embodiment, a chipset 507 is also coupled to interconnect 505. Chipset 507 may include a memory control component (MC) 510. MC 510 may include an integrated graphics device that performs all or part of AVC encoding and decoding including ILDB. MC 510 may also include an AGP bus that allows a plug-in AGP graphics card to be connected to system and function as graphics subsystem to perform AGP encoding and decoding. MC 510 may include a memory controller 512 that is coupled to a main system memory 515. Main system memory 515 stores data and sequences of instructions that are executed by CPU 502 or any other device included in system 500.

In one embodiment, main system memory 515 includes one or more DIMMs incorporating dynamic random access memory (DRAM) devices; however, main system memory 515 may be implemented using other memory types. Additional devices may also be coupled to interconnect 505, such as multiple CPUs and/or multiple system memories.

MC 510 may be coupled to an input/output control component (IC) 540 via a hub interface. IC 540 provides an interface to input/output (I/O) devices within computer system 500. IC 540 may support standard I/O operations on I/O interconnects such as peripheral component interconnect (PCI), universal serial interconnect (USB), low pin count (LPC) interconnect, or any other kind of I/O interconnect (not shown). In one embodiment, IC 540 is coupled to a graphics interface card 550. Graphics interface card 550 includes a GPU.

It is appreciated that a lesser or more equipped system than the example described above may be desirable for certain implementations. Therefore, the configuration of system 500 may vary from implementation to implementation depending upon numerous factors, such as price constraints, performance requirements, technological improvements, and/or other circumstances.

It should be noted that, while the embodiments described herein may be performed under the control of a programmed processor, such as CPU 502 or GPU 555, in alternative embodiments, the embodiments may be fully or partially implemented by any programmable or hard coded logic, such as field programmable gate arrays (FPGAs), transistor transistor logic (TTL) logic, or application specific integrated circuits (ASICs). Additionally, the embodiments of the invention may be performed by any combination of programmed general-purpose computer components and/or custom hardware components. Therefore, nothing disclosed herein should be construed as limiting the various embodiments of the invention to a particular embodiment wherein the recited embodiments may be performed by a specific combination of hardware components.

In the above description, numerous specific details such as logic implementations, opcodes, resource partitioning, resource sharing, and resource duplication implementations, types and interrelationships of system components, and logic partitioning/integration choices may be set forth in order to provide a more thorough understanding of various embodiments of the invention. It will be appreciated, however, to one skilled in the art that the embodiments of the invention may be practiced without such specific details, based on the disclosure provided. In other instances, control structures, gate level circuits and full software instruction sequences have not been shown in detail in order not to obscure the invention. Those of ordinary skill in the art, with the included descriptions, will be able to implement appropriate functionality without undue experimentation.

The various embodiments of the invention set forth above may be performed by hardware components or may be embodied in machine-executable instructions, which may be used to cause a general-purpose or special-purpose processor or a machine or logic circuits programmed with the instructions to perform the various embodiments. Alternatively, the various embodiments may be performed by a combination of hardware and software.

Various embodiments of the invention may be provided as a computer program product, which may include a machine-readable medium having stored thereon instructions, which may be used to program a computer (or other electronic devices) to perform a process according to various embodiments of the invention. The machine-readable medium may include, but is not limited to, floppy diskette, optical disk, compact disk-read-only memory (CD-ROM), magneto-optical disk, read-only memory (ROM) random access memory (RAM), erasable programmable read-only memory (EPROM), electrically erasable programmable read-only memory (EEPROM), magnetic or optical card, flash memory, or another type of media/machine-readable medium suitable for storing electronic instructions. Moreover, various embodiments of the invention may also be downloaded as a computer program product, wherein the program may be transferred from a remote computer to a requesting computer by way of data signals embodied in a carrier wave or other propagation medium via a communication link (e.g., a modem or network connection).

Similarly, it should be appreciated that in the foregoing description, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as the invention.

What is claimed is:

1. A method, comprising:
receiving a video input including a frame to be in-loop deblocked by an in-loop deblock (ILDB) filter;
determining whether a macroblock (MB) of one row of the frame satisfies prerequisite conditions for the MB to be in-loop deblocked, the prerequisite conditions including an immediate left neighbor and an immediate upper-right neighbor of the MB both having completed in-loop deblocking by the ILDB filter;
in-loop deblocking, by the ILDB filter, the MB if the MB satisfies the prerequisite conditions; and
concurrently starting the ILDB filter on another MB in another row of the frame, the another MB having also satisfied the conditions.

2. The method of claim 1, wherein the MB and the another MB are concurrently in-loop deblocked by the ILDB filter on multiple threads of a multiple core processor.

3. The method of claim 1, further comprising concurrently in-loop deblocking by the ILDB filter one or more other MBs each on different rows of the frame than any other MB currently being in-loop deblocked.

4. The method of claim 1, wherein the frame is an interlaced frame encoded in a MB adaptive frame/field (MBAFF) mode and wherein each MB being in-loop deblocked is a pair of MBs.

5. The method of claim 1, further comprising utilizing one or more 1-dimensional (1-D) scoreboards to track the status of each of the MBs being ILDB filtered.

6. The method of claim 5, wherein each MBs luma and chroma components are concurrently ILDB filtered on separate root threads and each tracked one of the 1-D scoreboards.

7. The method of claim 1, wherein the maximum number of MBs concurrently in-loop deblocked by the ILDB filter is the number of MBs in a height of the frame.

8. An apparatus, comprising:
an input data bitstream including a frame of macroblocks (MBs);
an decoder to decompress the input data bitstream; and
an in-loop deblocking (ILDB) filter of the decoder to:
receive the frame to be in-loop deblocked by the ILDB filter;
determine whether a MB of one row of the frame satisfies prerequisite conditions for in-loop deblocking to be performed on the MB, the conditions including an immediate left neighbor and an immediate upper-right neighbor of the MB both having completed in-loop deblocking by the ILDB filter;
in-loop deblocking the MB if the MB satisfies the prerequisite conditions; and
concurrently in-loop deblocking another MB in another row of the frame, the another MB having also satisfied the prerequisite conditions.

9. The apparatus of claim 8, wherein the MB and the another MB are concurrently in-loop deblocked by the ILDB filter utilizing multiple threads of a multiple core processor.

10. The apparatus of claim 8, wherein the ILDB filter further to concurrently in-loop deblock one or more other MBs that are each on different rows of the frame than any other MBs being in-loop deblocked.

11. The apparatus of claim 1, wherein the frame is an interlaced frame encoded in a MB adaptive frame/field (MBAFF) mode and wherein each MB being in-loop deblocked is a pair of MBs.

12. The apparatus of claim 10, wherein the ILDB filter further to utilize one or more 1-dimensional (1-D) scoreboards to track the status of each of the MBs being in-loop deblocked.

13. The apparatus of claim 10, wherein each MBs luma and chroma components are concurrently in-loop deblocked on separate root threads.

14. The apparatus of claim 10, wherein the maximum number of MBs concurrently in-loop deblocked is the number of MBs in a height of the frame.

15. An article of manufacture comprising a machine-readable medium including data that, when accessed by a machine, cause the machine to perform operations comprising:
receiving a video input including a frame to be in-loop deblocked by an in-loop deblock (ILDB) filter;
determining whether a macroblock (MB) of one row of the frame satisfies prerequisite conditions for the MB to be in-loop deblocked, the prerequisite conditions including an immediate left neighbor and an immediate upper-right neighbor of the MB both having completed in-loop deblocking by the ILDB filter;
in-loop deblocking, by the ILDB filter, the MB if the MB satisfies the prerequisite conditions; and
concurrently starting the ILDB filter on another MB in another row of the frame, the another MB having also satisfied the conditions.

16. The article of manufacture of claim 15, wherein the MB and the another MB are concurrently in-loop deblocked by the ILDB filter on multiple threads of a multiple core processor.

17. The article of manufacture of claim 15, wherein the machine-accessible medium further includes data that cause the machine to perform operations comprising concurrently in-loop deblocking by the ILDB filter one or more other MBs each on different rows of the frame than any other MB currently being in-loop deblocked.

18. The article of manufacture of claim 15, wherein the machine-accessible medium further includes data that cause the machine to perform operations comprising utilizing one or more 1-dimensional (1-D) scoreboards to track the status of each of the MBs being ILDB filtered.

19. The article of manufacture of claim 15, wherein each MBs luma and chroma components are concurrently ILDB filtered on separate root threads and each tracked one of the 1-D scoreboards.

20. The article of manufacture of claim 15, wherein the maximum number of MBs concurrently in-loop deblocked by the ILDB filter is the number of MBs in a height of the frame.
